(19) United States
(12) Patent Application Publication
(10) Pub. No.: US 2002/0122436 A1
(43) Pub. Date: Sep. 5, 2002

(54) Serial communication device

(75) Inventor: Masaya Otokawa, Gifu-shi (JP)

Correspondence Address: SUGHRUE MION, PLLC, 2100 Pennsylvania Avenue, NW, Washington, DC, 20037-3213, US

(73) Assignee: AISIN SEIKI KABUSHIKI KAISHA

(21) Appl. No.: 10/077,759

(22) Filed: Feb. 20, 2002

(30) Foreign Application Priority Data
Feb. 21, 2001 (JP) 2001-044887

(51) Int. Cl. H04J 3/06

(52) U.S. Cl. 370/503

(57) ABSTRACT

A clock signal SCLK is provided to an input/output interface and communication data SIN consisting of a predetermined frame including a predetermined bits with a parity bit P is transmitted to an electronic circuit at a synchronized timing with the clock signal SCLK. A parity check is performed at a synchronized timing with an output of a communication completion condition synchronized with the clock signal SCLK and the communication contents are checked by the parity bit P.

### CROSS REFERENCE TO RELATED APPLICATIONS

This application is based on and claims priority under 35 U.S.C. §119 with respect to Japanese Patent Application 2001-044887, filed on Feb. 21, 2001, the entire content of which is incorporated herein by reference.

### FIELD OF THE INVENTION

This invention relates to a serial communication device for communicating communication data consisting of a number of predetermined frames including a number of predetermined bits with a parity bit by synchronization with a synchronous serial communication clock signal inputted from an exterior device with an electronic circuit without a clock device.

### BACKGROUND OF THE INVENTION

Conventionally, when data communication is performed based on an instruction by a micro-controller etc. on an electronic circuit, two communication methods such as a serial communication and a parallel communication are well known.

In a digital circuit includes a clock (clock except a synchronizing serial communication clock signal) to be operated in a circuit, the parallel and serial communications can be adopted. However, On an analog circuit and a digital circuit without the clock for operating the circuit, normally, the parallel communication which directly communicates an instruction by the micro-controller etc. is adopted. Therefore, when the micro-controller operates based on an instruction contents by the analog circuit and the digital circuit, the parallel communication is adopted, but if the parallel communication is adopted, the parallel communication causes an increasing of terminal numbers for executing the data communication, a mounting area of the terminals, and the cost of an integrated circuit.

For the digital circuit without the clock for operating the circuit, a data communication of the instruction contents by the micro-controller etc. is performed by the serial communication, a data communication method for changing the instruction contents from a serial communication to a parallel communication is known. Further, all-purpose logical circuit used for changing the serial data to the parallel data is known (e.g. FUJITSU SEMICONDUCTOR DEVICE DATA SHEET; DS03-82401-2 etc.). However, the data communication is performed without a check of the communication contents on the abovementioned logical circuit and it is difficult to adopt the application used for a field (e.g. an electronic control apparatus etc. used for a vehicle) needing reliability.

By the way, when a digital circuit with a clock for operating the circuit of an electronic control apparatus etc. for the vehicle is adopted, it causes an integral multiple noise of the clock frequency, and the noise really leaks to the exterior of the electronic control apparatus. The leaked noise causes defects for other electronic control apparatus. Therefore, an extra clock should be used in an electronic circuit of an electronic control apparatus.

Further, when the digital circuit includes a clock for operating the circuit in an integrated circuit, including an analog and digital hybrid circuit, as an oscillator so as to generate the clock signals for operating the circuit is connected in the circuit, the oscillator breaks down or connecting defects due to connecting with the oscillator occur, and the odds of defects being generated in the integrated circuit becomes very large.

### SUMMARY OF THE INVENTION

In view of the foregoing, it is an object of the present invention to provide a serial communication device performing a serial communication without a clock for operating the circuit and checking communication contents correctly.

According to a first aspect of the present invention, a serial communication device synchronizing with a synchronizing serial communication clock signal from an exterior device and communicating communication data including predetermined frames consisting of predetermined bits and a parity bit with an electronic circuit with respect to each bit includes a monitor circuit synchronizing with the synchronizing serial communication clock signal and outputting a communication completion condition signal at a timing counted a predetermined bit for the communication data, and a check circuit for checking communication contents by the parity bit at a time synchronized with an output of the communication completion condition signal.

According to a second aspect of the present invention, a serial communication device synchronizing with a synchronizing serial communication clock signal from an exterior device and communicating communication data including predetermined frames consisting of predetermined bits with a parity bit with an electronic circuit with respect to each bit includes a monitor circuit synchronized with the synchronizing serial communication clock signal and outputting a communication completion condition signal at a timing counted by a predetermined bit for the communication data, and a check circuit for checking a communication contents by the parity bit at a timing synchronized by the communication completion condition signal with the synchronized serial communication clock signal.

According to a third aspect of the present invention, a serial communication device inputted an active signal and a synchronizing serial communication clock signal from an exterior device, and at a timing synchronized with the synchronizing serial communication clock signal under an active condition of the active signal and communicating a communication data including predetermined frames consisting of predetermined bits with a parity bit with an electronic circuit with respect to each bit includes judging means for judging a switching condition of the active signal, and checking means for checking a communication contents by the parity bit at a timing switching between the positive condition to the negative condition.

According to a fourth aspect of the present invention, the checking means checks the communication contents when the active signal changes from the active condition to the negative condition.

Thus, as the serial communication device is operated by the synchronizing serial communication clock signal (the active signal) from the exterior device, the communication contents can be checked. For example, as a plurality of circuits (serial communication device) for controlling an input/output except a microcontroller are operated by the synchronizing serial communication clock signal from the micro-controller on the electronic control device, the number of needed clocks can be restricted to a minimum in an electronic control device, and high frequency noise leaking out the electronic control device can be reduced.

Further, an oscillator does not need for the above-mentioned serial communication device, as the serial communication device does not need operate synchronizing with a exterior oscillator, a generation of operation defects on the digital circuit and whole of integrated circuits by disconnecting with the oscillator can be avoided.

Furthermore, as the serial communication is performed, an exterior oscillator and the communication contents are checked, high reliability for the serial communication can be obtained by integrated circuits including only analog circuits without using exterior parts.

### BRIEF DESCRIPTION OF THE DRAWINGS

The features and advantages of a serial communication device according to the present invention, will be more clearly appreciated from the following description considered in conjunction with the accompanying drawing figures in which like elements bear like reference numerals and wherein:

FIG. 1 is a block diagram of a serial communication device according to an embodiment of present invention.

FIG. 2 is a timing chart of the serial communication device according to the embodiment of the present invention.

FIG. 3 is a block diagram of an ECU as a controller according to the embodiment of the present invention.

FIG. 4 is a timing chart of a serial communication device according to another embodiment of the present invention.

### DETAILED DESCRIPTION OF THE INVENTION

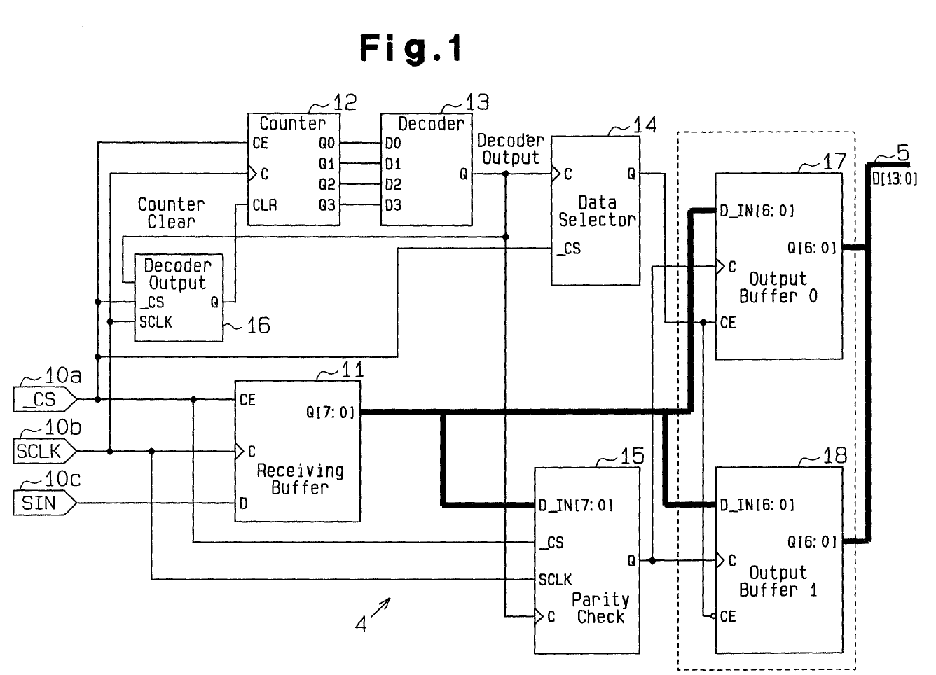

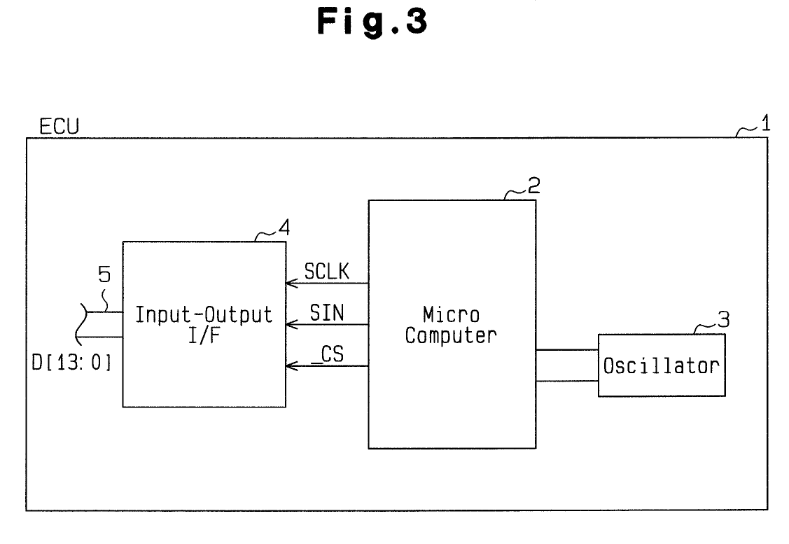

Hereinafter, a preferable embodiment of the present invention will be described referring to FIGS. 1-3. FIG. 3 is a block diagram showing an electronic control unit (ECU) for a vehicle. The control of each electronic device performed by the ECU 1 repeats a few milli-seconds, the microcomputer (micro-controller) 2 executes an input/output of a communication data between an outside devices per one cycle. In other words, the microcomputer 2 is connected with the exterior device by a serial connection, the microcomputer 2 controls each electronic device by inputting/outputting the data communication between the exterior devices on the communication speed finishing the data communication within the cycle.

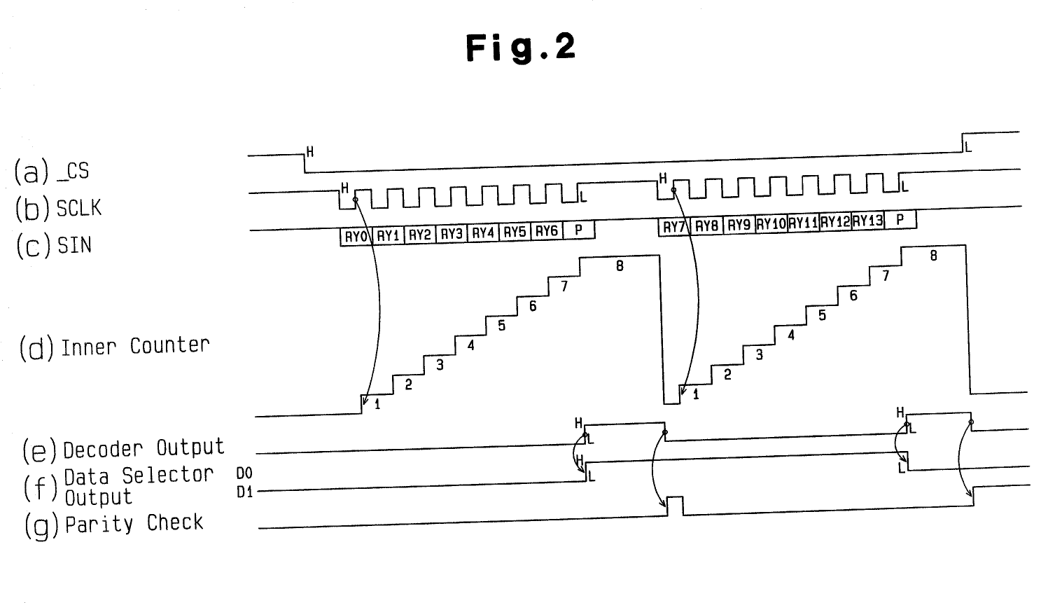

For example, the microcomputer 2 generates a chip select signal CS (underscore “_” shows a low activity) so as to activate an input/output interface 4. As shown in FIG. 2(a), the chip select signal CS is normally high level (high potential). When the chip select signal CS makes an active condition for the input/output interface 4, the chip select signal CS changes from the high level to low level (low potential).

Further, the microcomputer 2 generates a clock signal SCLK such as a synchronizing serial communication clock signal outputting a standard clock for the input/output interface 4 based on an oscillating signal generated by the oscillator 3. As shown in FIG. 2(b), the clock signal SCLK is normally high level, when the chip select signal CS is low level and the input/output interface is in active condition, a negative edge changing the signal edge of the clock signal SCLK from high level to low level and a positive edge changing the signal edge of the clock signal SCLK from low level to high level repeats eight times at each predetermined time, two signal groups with eight positive edges and eight negative edges is generated within the predetermined time.

Further, the microcomputer 2 generates the serial data SIN such as communication data for instructing the input/output interface 4 based on an output setting condition of each IC. As shown in FIG. 2(c), the serial data SIN comprises a packet by a first frame with eight bit data consisting of data RY0-RY6 showing the output setting condition of a predetermined IC and a parity bit P based on data RY0-RY6, and a second frame with eight bit data consisting of data RY7-RY13 showing the output setting condition of another IC and a parity bit P based on data RY7-RY13. In other words, the chip select signal CS maintains low level so as to activate the input/output interface 4 when the packet with two frames is communicating. Further, each parity bit P detects a data transmitting error by making an even number (or odd number) of the number of “1” in a frame.

Further, each successive data RY0-RY6 and the parity P in the first frame, each successive data RY7-RY13 and parity P in the second frame are communicated under a condition synchronized with a negative edge of the clock signal SCLK changing from high level to low level.

The input/output interface 4 inputs the chip select signal CS, the clock signal SCLK, and the serial data SIN from the microcomputer 2. Further, the serial data SIN is changed to the parallel data according to a condition of these signals, the serial-parallel changed parallel data D [13:0] are outputted from a data bus to each exterior device.

FIG. 1 is a block diagram showing the input/output interface 4 according to the present embodiment. As shown in FIG. 1, the input/output interface 4 comprises a receiving buffer 11, a counter 12 comprising a monitor circuit, a decoder 13, a data selector 14, a parity check circuit 15 such as a check circuit, a counter clear circuit 16 comprising the monitor circuit, a first output buffer 17, and a second output buffer 18.

The receiving buffer 11 is a shift register (e.g. 8 bit shift register), the receiving buffer 11 memorizes parallel data changed from the serial data. The receiving buffer 11 is connected with each terminal 10a, 10b, and 10c for inputting the chip select signal CS, the clock signal SCLK, and the serial data SIN respectively. The receiving buffer 11 synchronizes with a negative edge of the clock signal SCLK changing from high level to low level, the receiving buffer 11 memorizes outputted data from eight outputs Q [7:0](bit 7-bit 0) by shifting data RY0-RY6 and the parity P in the serial data SIN or data RY7-RY13 and the parity P of the serial data SIN in turn.

The counter 12 is a bit counter (e.g. a 4 bit counter), a number of the received data (data RY0-RY6 and a parity P, data RY7-RY13 and a parity P) in the serial data SIN counts. The counter 12 is connected with the chip select signal CS and each of the terminals 10a, 10b for inputting the clock signal SCLK. As shown in FIG. 2(d), the counter 12 synchronizes with a positive edge of the clock signal SCLK changing from low level to high level when the chip select signal CS is low level, the counter 12 counts a number of data RY0-RY6 and a parity P in the first frame of the serial data SIN, data RY7-RY13 and a parity P in the second frame of the serial data SIN.

Further, after the counter 12 counts from “1” to “8” for a number of data in a first frame including data RY0-RY6, and a parity P, the counter 12 is cleared. Further, the counter 12 counts a number (“1-8”) of data in second frame including data RY7-RY13 and a parity P.

Detailed description, an output of the counter 12 inputs into the decoder 13. As shown in FIG. 2(e), an output Q of the decoder 13 synchronizes with “8” count of the counter 12 for the first frame, the output of the counter 12 changes from low level to high level. Thereby, a communication completion condition of the first frame is set. Further, the output Q of the decoder 13 synchronizes with a negative edge of next clock signal SCLK changing from high level to low level, the output Q of the decoder 13 returns to low level again. Thereby, a communication starting condition of the second frame is set. The output Q of the decoder 13 is inputted in the counter 12 via the counter clear circuit 16, and a count value of the counter 12 is cleared.

Further, as shown in FIG. 2(e), the output Q of the decoder 13 is synchronized with a count value “8” of the counter 12 for the second frame, the output Q changes from low level to high level again. Thereby, a communication completion condition of the second frame is set. Further, the output Q of the decoder 13 synchronizes with a rise condition changing from low level to high level of the chip select signal CS, the output Q thereof returns to low level again. That is, the condition of the input/output interface 4 is not active and the communication completion condition of the packet is set. The output Q of the decoder 13 is inputted in the counter 12 via the counter clear 16 and a count of the counter 12 is cleared.

The chip select signal CS and the output Q of the decoder 13 are inputted in the data selector 14. As shown in FIG. 2(f), the data selector 14 outputs the signal D1 of normally low level for the first and second output buffers from the output Q of the data selector 14. Further, when the output Q of the decoder 13 changes from low level to high level according to the first frame while the chip select signal CS is low level, the signal D0 which is high level outputs the communication data from the output Q of the data selector 14 to the first and second buffers 17, 18 at a synchronized timing with the positive edge. In this case, the first output buffer 17 is only made an active condition. Subsequently, when the output Q of the decoder 13 changes low level to high level according to the second frame, the signal D1 which is low level outputs from the output Q of the decoder 13 to the first and second buffers 17, 18 at a synchronized timing with the positive edge of the output Q of the decoder 13. In this case, the second output buffer 18 is placed in an active condition.

Each output Q [bit 7-bit 0] of the receiving buffer 11 is inputted in D_IN [bit 7-bit 0] on the parity check circuit 15, a data transmitting error is detected whether a number of “1” in each frame (data RY0-RY6 and a parity P or data RY7-RY13 and a parity P) is an even number (or an odd number). The parity check circuit 15 connects with each terminal 10a, 10b for inputting the chip select signal CS and the clock signal SCLK. As shown in FIG. 2(g), the parity check circuit 15 outputs a parity latch rising within a predetermined time under a condition synchronized with changing from high level to low level of the decoder 13 from the output Q to the first and second output buffers 17, 18 only when data in the frame is a normal condition while the chip select signal CS is low condition.

The chip select signal CS and the clock signal SCLK are inputted in the counter clear circuit 16, and the output Q of the decoder 13. As shown in FIG. 2(d), the counter clear circuit 16 clears the counter value of the counter 12 at a synchronized timing with the communication starting condition of the second frame or the communication end condition of the packet.

The first and second buffers 17, 18 are output registers (e.g. 7 bit output registers) respectively, each input D_N [bit 6-bit 0] supplied from the outputs Q (bit 7-bit 0 except a parity bit) of the receiving buffer 11. Further, the output Q (which is a signal condition D0 or D1) of the data selector 14 and output Q (parity latch) of the parity check circuit 15 are inputted in the first and second output buffers 17, 18.

The first output buffer 17 outputs bit data (RY0-RY6) of the input D_IN (bit 6-bit 0) on the data bus 5 from the outputs Q (bit 6-bit 0) of the first output buffer 17 at a synchronized timing with the signal D0 when the inputted signal from the data selector 14 is D0 and the communication content from the parity check circuit 15 is a normal condition (e.g. a positive edge of the parity latch changing from low level to high level).

On the other hand, the second buffer 18 outputs bit data (RY7-RY13) of the input D_IN (bit 6-0) on the data bus 5 from the outputs Q (bit 6-0) at a synchronized timing with the signal D1 when the inputted signal from the data selector 14 is D1 and the communication content from the parity check circuit 15 is a normal condition (e.g. a positive edge of the parity latch changing from low level to high level).

(1) According to the present embodiment as above-mentioned, effects as follows will be obtained.

That is, in this embodiment, the parity bit in the communication contents can be checked at the synchronized timing with the output of the communication completion condition of the frame of the communication data by the counter 12 synchronized with the clock signal SCLK and the decoder 13.

(2) In this embodiment, the parity bit in the communication contents can be checked at a synchronized timing with a negative condition by the chip select signal CS.

In this embodiment, the input/output interface 4 is operated by the clock signal SCLK and the chip select signal CS from the exterior device and the communication contents can checked. Accordingly, a clock number needed in the ECU 1 can be restricted a minimum. Further, high frequency noise leaking from the ECU 1 to the exterior device can be reduced.

Further, for the above-mentioned input/output interface 4, since the serial communication device does not have to connect with the oscillator 3 and the serial communication device is not operated by the oscillator 3, an operation defect of all of the circuits by disconnecting with the oscillator 3 can be avoided.

(3) For example, conventionally, a circuit constructed by discrete parts (e.g. a switch input interface circuit, an analog sensor input interface circuit, a motor driving circuit, and a lamp driving circuit etc.) can be integrated in one chip IC. In this case, if the input/output of the communication data between the microcomputer 2 and the exterior device does not use a parallel communication but a serial communication, a terminal number for using the data communication can be reduced. Further, as the serial communication device is constructed by a smaller digital circuit relatively, the serial communication device can be only made integrated digital circuits by bipolar transistors, thereby the integrated circuits can be manufactured by low cost.

Further, the present invention is not limited to the above-mentioned embodiment and the present invention may be change as follows.

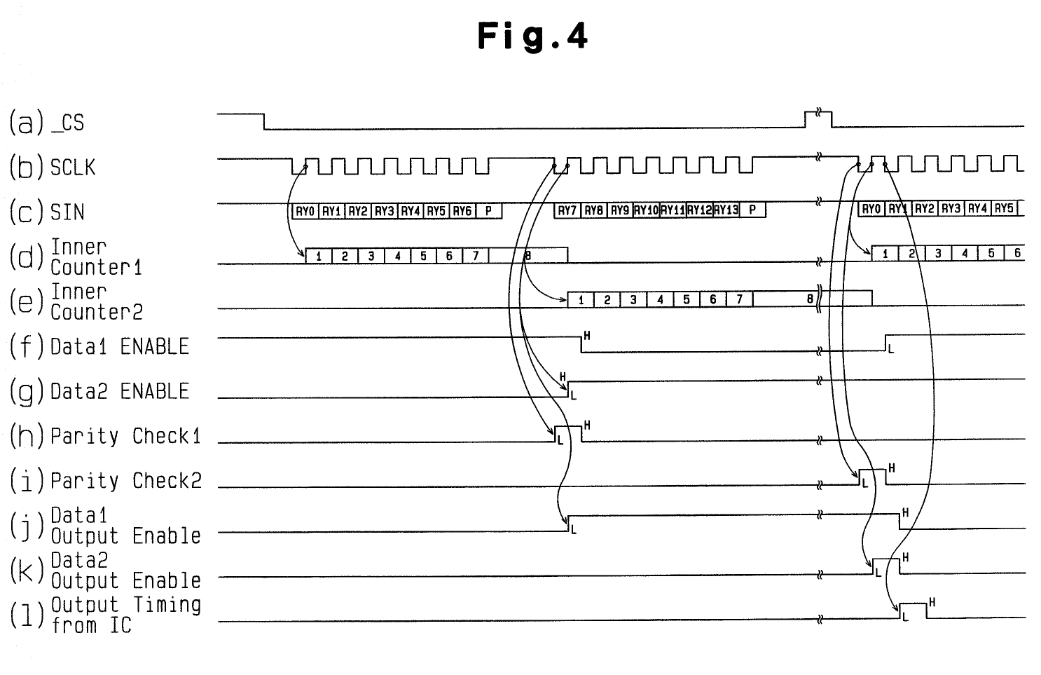

That is, in this embodiment, all circuit operations including the output signal from the data selector 14, a check (e.g. parity check) of the communication contents etc. may be synchronized with the clock signal SCLK. For example, FIG. 4 shows a timing chart of an operation on another circuit construction according to the present invention. In the embodiment, a packet communication formed by a frame with an 8 bit (data RY0-RY6 and a parity bit P based on data RY0-RY6) and a frame with an 8 bit (data RY7-RY13 and a parity bit P based on data RY7-RY13) is performed. However, the counter 1 for counting data number (1-8) in the first frame (data RY0-RY6 and the parity P) and the counter 2 for counting data number (1-8) in a second frame (data RY7-RY13 and the parity P) may be counted at a synchronized timing with a positive edge of the clock signal changing from low level to high level. While the data 1 ENABLE (shown in FIG. 4(f)) and data 2 ENABLE (shown in FIG. 4(g)) are high level, data in each frame can change to an active condition respectively.

When the communication content is only a normal condition, a parity check for the first frame changes from low level to high level during a predetermined time at a synchronized timing with a first negative edge of the clock signal SCLK for the second frame (shown in FIG. 4(h)). Further, while the parity check for the first frame is a high condition, the data 1 output enable signal is changed to an active condition at a synchronized timing with next positive edge of the clock signal SCLK (shown in FIG. 4(j)).

On the other hand, when the communication content is only a normal condition, the parity check for the second frame changes low level to high level within a predetermined time at a predetermined time synchronized with a first negative edge of the clock signal SCLK for a first frame of a next packet (shown in FIG. 4(i)). Furthermore, while the parity check for the second frame is high level, the data 2 output enable signal is an active condition at a timing synchronized with a next rise condition of the clock signal SCLK (shown in FIG. 4(k).

An output of data is performed at a synchronized timing with a positive edge of the next clock signal SCLK under active conditions of the data 1 output enable signal and the data 2 output enable signal (shown in FIG. 4(i)). According to the above-mentioned circuit construction, a check of the communication contents by the parity bit P can be performed at a synchronized timing with an output of a communication starting condition of a new frame.

In the present embodiment, one packet includes two frames, but one packet may be include one frame and more than three frames. Further, bit number in each frame may be includes a parity bit.

Further, in the present embodiment, the serial communication device is constructed from digital circuits, but the serial communication circuit may be constructed from an analog circuit or an analog/digital hybrid circuit. Particularly, the serial communication device includes an IC manufactured by only analog circuits without using extra parts can be a serial communication device without an exterior oscillator 3, the communication contents can be checked, a high reliability for the serial communication can be obtained.

In the present embodiment, the above-mentioned circuit construction is only an embodiment.

According to the present invention, the serial communication device can perform the serial communication without a clock such as a oscillator for operating a circuit and the check of the communication contents can be executed.

The invention may be embodied in other specific forms without departing from the spirit or essential characteristic thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A serial communication device synchronizing with a synchronizing serial communication clock signal from an exterior device and communicating a communication data including a predetermined frames consisting of predetermined bits with a parity bit with an electronic circuit with respect to each bit comprising:
a monitor circuit synchronizing with the synchronizing serial communication clock signal and outputting a communication completion condition signal at a timing counted by the predetermined bit for the communication data; and
a check circuit for checking communication contents by the parity bit at a time synchronized with an output of the communication completion condition signal.

2. A serial communication device synchronizing with a synchronizing serial communication clock signal from an exterior device and communicating a communication data including predetermined frames consisting of a predetermined bits and a parity bit with an electronic circuit with respect to each bit comprising:
a monitor circuit synchronizing with the synchronizing serial communication clock signal and outputting a communication completion condition signal at a timing counted by a predetermined bit for the communication data; and
a check circuit for checking a communication contents by the parity bit at a timing synchronized the communication completion condition signal with the synchronized serial communication clock signal.

3. A serial communication device inputted an active signal and a synchronizing serial communication clock signal from an exterior device, and at a timing synchronized with the synchronizing serial communication clock signal under an active condition of the active signal and communicating a communication data including predetermined frames consisting of predetermined bits and a parity bit with an electronic circuit with respect to each bit comprising:
judging means for judging a switching condition of the active signal, and checking means for checking a communication contents by the parity bit at a timing switching between the positive condition to the negative condition.

4. A serial communication device according to claim 3, wherein
the checking means checks the communication contents when the active signal changes from the active condition to the negative condition.
